(19) United States
(12) Patent Application Publication
(10) Pub. No.: US 2024/0217375 A1
(43) Pub. Date: Jul. 4, 2024

(54) ELECTRIC VEHICLE SMART CHARGING SYSTEM

(71) Applicant: MICRO-STAR INT’L CO.,LTD., New Taipei City (TW)

(72) Inventors: Chuan Yi LIN, New Taipei City (TW); Chung Ming CHAN, New Taipei City (TW); Ming Huei CHANG, New Taipei City (TW); Szu Hsien WU, New Taipei City (TW)

(73) Assignee: MICRO-STAR INT’L CO.,LTD., New Taipei City (TW)

(21) Appl. No.: 18/535,993

(22) Filed: Dec. 11, 2023

Related U.S. Application Data
(60) Provisional application No. 63/436,065, filed on Dec. 29, 2022.

(51) Int. Cl. B60L 53/65; B60L 53/16; B60L 53/30; B60L 53/31; B60L 53/68; G06V 10/44; G06V 10/774; G06V 20/62; H02J 7/00

(52) U.S. Cl. CPC B60L 53/65; B60L 53/16; B60L 53/305; B60L 53/31; B60L 53/68; G06V 10/44; G06V 10/774; G06V 20/625; H02J 7/0042

(57) ABSTRACT

An electric vehicle smart charging system includes at least one smart charging pile and a cloud management center. Each of the at least one smart charging pile includes a charging gun, a power supply circuit, a camera module and a signal processing circuit. The power supply circuit is configured to provide electric power to the charging gun. The camera module is configured to capture at least one image associated with a vehicle. The signal processing circuit has at least one recognition model and is configured to use the at least one recognition model to perform an edge computation on the at least one image and control the power supply circuit according to a result of the edge computation. The cloud management center is configured to update the at least one recognition model of the signal processing circuit according to the result from the signal processing circuit.

### CROSS-REFERENCE TO RELATED APPLICATIONS

This non-provisional application claims priority under 35 U.S.C. § 119(a) on Patent Application No(s). 63/436,065 filed in US on Dec. 29, 2022, the entire contents of which are hereby incorporated by reference.

### BACKGROUND

### 1. Technical Field

This disclosure relates to a smart charging system, especially to an electric vehicle smart charging system.

### 2. Related Art

So far, most charging piles on the market only have basic charging-related functions. The necessary parking spaces related to charging piles need management that require additional systems or equipment or manual management.

In addition, with the development of smart cities with the Artificial Intelligence of Things (AIOT), issues that need to be faced in the future include how countries around the world build various types of sensors and other smart devices required for smart cities.

### SUMMARY

Accordingly, this disclosure provides an electric vehicle smart charging system.

According to one or more embodiment of this disclosure, an electric vehicle smart charging system includes at least one smart charging pile and a cloud management center. Each of the at least one smart charging pile includes a charging gun, a power supply circuit, a camera module and a signal processing circuit. The power supply circuit is electrically connected to the charging gun and configured to provide electric power to the charging gun. The camera module is configured to capture at least one image associated with a vehicle. The signal processing circuit has at least one recognition model, electrically connected to the power supply circuit and the camera module, and is configured to use the at least one recognition model to perform an edge computation on the at least one image and control the power supply circuit according to a result of the edge computation. The cloud management center is in signal connection with the signal processing circuit and is configured to update the at least one recognition model of the signal processing circuit according to the result from the signal processing circuit.

In view of the above description, an electric vehicle smart charging system uses modules with machine vision and artificial intelligence recognition capabilities to perform smart charging and smart parking management to achieve designs of smart application and management. The recognition module on the application end of the smart charging system of the present disclosure is designed as an edge computation architecture, and model training is designed as a backend cloud computing architecture. The edge-computed images and inference information may be sent back to the cloud to supplement the deep learning image recognition training data set to correct wrong determination and perform learning again. Therefore, the accuracy of image recognition and labeling efficiency are effectively improved, and further deep learning is achieved. The trained recognition model is then updated via the Internet to improve the accuracy of artificial intelligence edge computation.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of an electric vehicle smart charging system according to an embodiment of the present disclosure;

FIG. 2 is an operation flow chart of an electric vehicle smart charging system according to an embodiment of the present disclosure;

FIG. 3 is an operation flow chart of an electric vehicle smart charging system according to another embodiment of the present disclosure;

FIG. 4 is a detailed operation flow chart of the electric vehicle smart charging system shown in the embodiment of FIG. 3;

FIG. 5 is an operation flow chart of an electric vehicle smart charging system according to still another embodiment of the present disclosure; and

FIG. 6 is a functional block diagram of an electric vehicle smart charging system according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

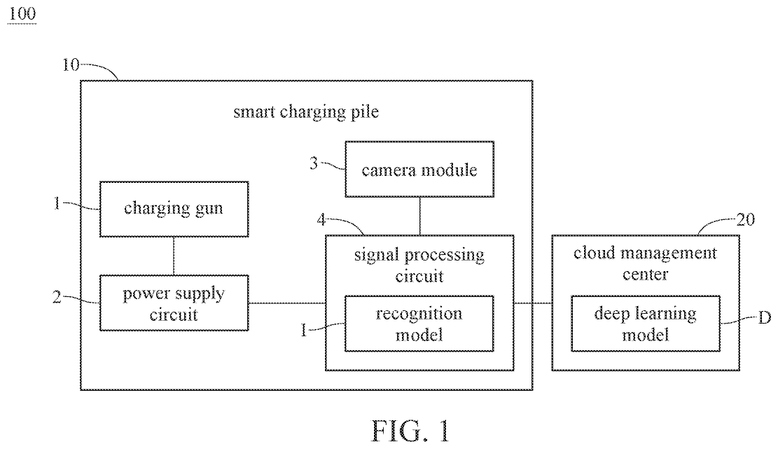

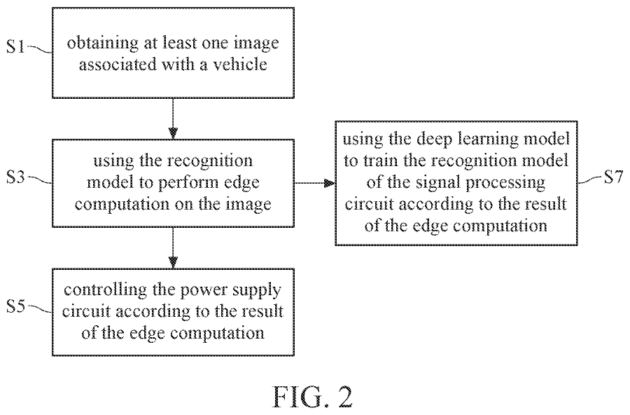

Please refer to FIG. 1 and FIG. 2, FIG. 1 is a functional block diagram of a electric vehicle smart charging system according to an embodiment of the present disclosure, FIG. 2 is an operation flow chart of an electric vehicle smart charging system according to an embodiment of the present disclosure. As shown in FIG. 1, an electric vehicle smart charging system 100 includes at least one smart charging pile 10 and a cloud management center 20. Each of the at least one smart charging pile 10 includes a charging gun 1, a power supply circuit 2, a camera module 3 and a signal processing circuit 4. The power supply circuit 2 is electrically connected to the charging gun 1 and configured to provide electric power to the charging gun 1. The camera module 3 is configured to capture at least one image associated with a vehicle. The signal processing circuit 4 has at least one recognition model I. The signal processing circuit 4 is electrically connected to the power supply circuit 2 and the camera module 3, and is configured to use the at least one recognition model I to perform an edge computation on the at least one image and control the power supply circuit 2 according to a result of the edge computation. The cloud management center 20 is in signal connection with the signal processing circuit 4 and is configured to update the at least one recognition model I of the signal processing circuit 4 according to the result from the signal processing circuit 4. Optionally, the cloud management center 20 has a deep learning model D. The cloud management center 20 is configured to use the deep learning model D to train the at least one recognition model I of the signal processing circuit 4 according to the result of the edge computation.

As shown in FIG. 2, the electric vehicle smart charging system 100 is configured to perform: step S1: obtaining at least one image associated with a vehicle; step S3: using the recognition model I to perform edge computation on the image; step S5: controlling the power supply circuit 2 according to the result of the edge computation; and step S7: using the deep learning model D to train the recognition model I of the signal processing circuit 4 according to the result of the edge computation. In the present embodiment, there is no specific sequence relationship between steps S5 and S7.

The electric vehicle smart charging system 100 may include a plurality of smart charging piles 10. Therefore, although the number of smart charging pile 10 shown in FIG. 1 is one, the present disclosure is not limited thereto. Each smart charging pile 10 may include a charging gun 1 of the same or different specifications. For example, two smart charging piles may include a charging gun 1 of the first specification (such as SAE J1772) and a charging gun 1 of the second specification (such as IEC 62196). The power supply circuit 2 is controlled by the signal processing circuit 4 to provide electric power to the charging gun 1. Specifically, the power supply circuit 2 may include a charging communication circuit, such as a circuit supporting a control pilot, for obtaining communication signals to adjust the charging power of the charging gun 1. The power supply circuit 2 may further include components controlled to adjust the power supply switch, such as relays, and components used to detect the magnitude of the power supply, such as current detectors. Furthermore, the electric vehicle smart charging system 100 may also respond to the power deployment plan of the charging site through the cloud management center. The cloud system distributes power plans for one or more electric vehicle smart charging systems 100. A group of smart charging piles 10 sharing a same power source execute a same power supply distribution plan result to perform power supply management. For each smart charging pile 10, regardless of whether the power supply indicated by the power plan of the cloud system is increased or decreased, different vehicle types may still be charged according to the condition that the maximum charging power acceptable by the vehicle is not exceeded. In addition, the current supply circuits of a plurality of smart charging piles may have their own power supply devices, or may be connected to a same power supply. The camera module 3 may be implemented through a camera or video equipment that captures images or videos.

The signal processing circuit 4 may include a plurality of processors, one of which may be implemented through a neural network processing unit (NPU), and is configured to process the image captured by the camera module 3 according to the recognition model I. Image recognition is performed on images to recognize vehicles, license plates and other characteristic objects. The neural network processing unit performs recognition through the recognition model in the memory. For example, the neural network processing unit may use object detection model trained by a specific neural network framework (such as TensorFlow Lite) and a specific model architecture (such as EfficientDet). In other words, this image recognition is realized through the computing capability of the signal processing circuit 4 itself, and therefore belongs to an edge computing architecture. The other processor(s) of the signal processing circuit 4 may be implemented through a microcontroller, a graphics processor, a programmable logic array, etc., and is configured to control the power supply circuit 2 based on the result of image recognition (edge computing). The cloud management center 20 may include a network host in signal connection with the signal processing circuit 4 from a remote end, and may include another neural network processing unit for using the deep learning model D to train the recognition model of the signal processing circuit based on the result of the edge computation described above.

In step S1, the camera module 3 may be triggered to capture images of the vehicle. For example, when the vehicle passes a specific sensing device, the sensing device may trigger the camera module 3 to start capturing images, and then transmit the images to the signal processing circuit 4. Alternatively, the camera module 3 may capture and transmit images to the signal processing circuit 4 periodically. In step S3, the signal processing circuit 4 may use the recognition model to perform edge computation on the image captured by the camera module 3. In one implementation, when the result of the edge computations indicates that there are no specific objects such as vehicles or license plates in the image, the system may re-execute step S1. In the above process, the vehicle object recognition result may be used to determine whether the vehicle status is to enter or leave the parking space; at the same time, the light recognition parameters of the camera module 3 may be used, and based on the recognition result of parameter, it is determined whether to adjust or control the charging pile and peripheral devices, such as auxiliary light sources, or display devices etc., and the optimization adjustment is not limited thereto.

In step S5, the signal processing circuit 4 may control the power supply circuit 2 according to the result of the edge computation. For example, when the result of edge computation indicates that the vehicle is an electric vehicle, the signal processing circuit 4 of the smart charging pile 10 may release the controlled peripheral device through the communication unit and open the charging parking space for parking. Or the smart charging pile 10 may cooperate with the signal processing circuit 4 to control the power supply circuit 2 to provide electric power to the charging gun 1. On the other hand, when the result of edge computation indicates that the vehicle is not an electric vehicle, then no power is provided. Therefore, an unsupervised smart mechanism is achieved. When the result of the edge computation indicates that the specification of the electric vehicle is consistent with the charging specification of the charging gun 1, the signal processing circuit 4 may control the power supply circuit 2 to provide electric power to the charging gun 1, otherwise no power will be provided. When the edge computing results or data exchange with the cloud management system confirm that the vehicle's license plate number belongs to a customer list, the smart charging pile 10 may release the controlled peripheral device through the communication unit according to the reservation or normal authorization results, and open the charging parking space for parking and use, or the smart charging pile 10 may cooperate with the signal processing circuit 4 to control the power supply circuit 2 to provide electric power to the charging gun 1. Therefore, additional authorization operations may be reduced and an unsupervised smart mechanism may be achieved. In step S7, the cloud management center 20 may use the above-described deep learning model to train the recognition model based on the results of edge computation. For example, the signal processing circuit 4 may transmit the license plate image to the cloud management center 20 to expand the image database of the cloud management center, so that the cloud database 20 may update and expand the amount of the license plate images in the image database, and use the updated image database to train the recognition model, and then send the new recognition model (or recognition model with different weights) back to the signal processing circuit 4 for model update.

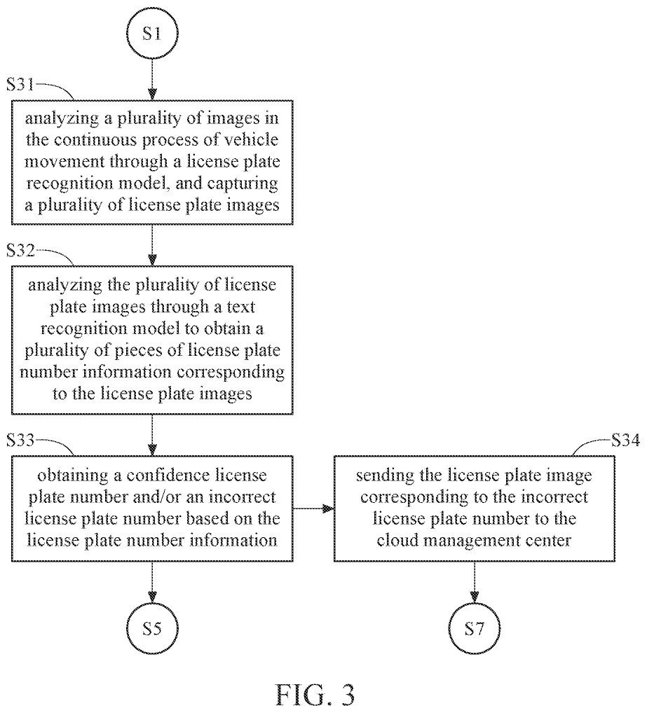

Please refer to FIG. 3 along with FIG. 2, FIG. 3 is an operation flow chart of an electric vehicle smart charging system according to another embodiment of the present disclosure. As shown in FIG. 3, after step S1, the electric vehicle smart charging system in the present embodiment may execute step S31: analyzing a plurality of images in the continuous process of vehicle movement through a license plate recognition model, and capturing a plurality of license plate images; step S32: analyzing the plurality of license plate images through a text recognition model to obtain a plurality of pieces of license plate number information corresponding to the license plate images; step S33: obtaining a confidence license plate number and/or an incorrect license plate number based on the license plate number information; and step S34: sending the license plate image corresponding to the incorrect license plate number to the cloud management center; and executing step S5 after step S33, and executing step S7 after step S34. It should be noted that in the present embodiment, “obtaining the incorrect license plate number” in step S33 is optional, and step S34 is optional.

In step S31, the signal processing circuit may capture the license plate image through the license plate recognition model, wherein the license plate recognition model may be implemented through using an object detection model trained by a neural network framework, such as TensorFlow Lite, and a model architecture, such as EfficientDet. For example, the license plate recognition model may capture license plate images from different viewing angles and distances while the vehicle is moving. In step S32, the signal processing circuit may analyze the license plate image through the text recognition model to obtain the corresponding license plate number information, wherein the text recognition model may be implemented through using an optical character recognition model trained by a neural network framework, such as TensorFlow Lite, and a model architecture, such as EfficientDet. In step S33, the signal processing circuit may count the plurality of pieces of license plate number information captured during the movement of the vehicle, and obtain a confidence license plate number with higher accuracy. For example, the signal processing circuit may regard the one with the highest repetition numbers among the plurality of pieces of license plate number information as the confidence license plate number, and regard other license plate number information that is different from the confidence license plate number as the incorrect license plate number. In step S34, the signal processing circuit may transmit the license plate image corresponding to the incorrect license plate number to the cloud management center, so that the cloud management center may retrain the recognition model for the incorrect license plate image in step S7. In step S5, the signal processing circuit may determine whether to activate the power supply circuit based on the above-described confidence license plate number. For example, the signal processing circuit may determine whether the confidence license plate number is the license plate number of an electric vehicle, and accordingly determine whether to activate the power supply circuit.

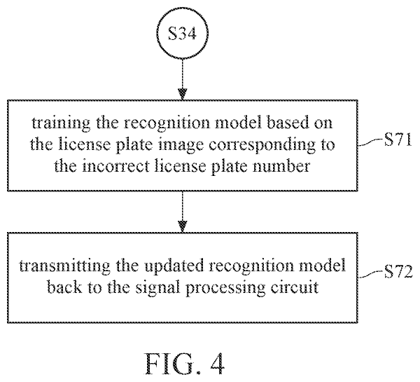

Please refer to FIG. 4, FIG. 4 is a detailed operation flow chart of the electric vehicle smart charging system shown in the embodiment of FIG. 3. As shown in FIG. 4, after step S34, the electric vehicle smart charging system executes step S71: training the recognition model based on the license plate image corresponding to the incorrect license plate number; and step S72: transmitting the updated recognition model back to the signal processing circuit. In the present embodiment, steps S71 to S72 may correspond to step S7 in FIG. 2. In step S71, the cloud management center may obtain the recognition model from the signal processing circuit, and then use the license plate image corresponding to the incorrect license plate number as part of the training data set, and use the above-described deep learning model to train the recognition model to update the weight values of the neurons of the neural network of the recognition model. In step S72, when the above training is completed, the cloud management center can send the updated recognition model back to the signal processing circuit for update.

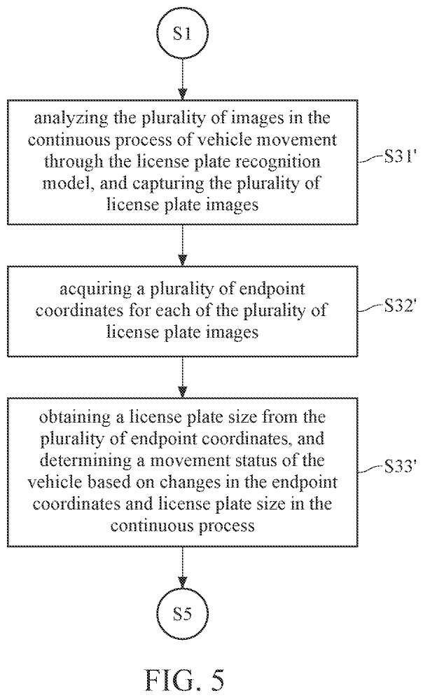

Please refer to FIG. 5, FIG. 5 is an operation flow chart of an electric vehicle smart charging system according to still another embodiment of the present disclosure. As shown in FIG. 5, after step S1, the electric vehicle smart charging system in the present embodiment may execute step S31′: analyzing the plurality of images in the continuous process of vehicle movement through the license plate recognition model, and capturing the plurality of license plate images; step S32′: acquiring a plurality of endpoint coordinates for each of the plurality of license plate images; step S33′: obtaining a license plate size from the plurality of endpoint coordinates, and determining a movement status of the vehicle based on changes in the endpoint coordinates and license plate size in the continuous process; and the step S5.

Step S31′ in the present embodiment may correspond to step S31 shown in FIG. 3. In step S32′, the signal processing circuit may capture a plurality of endpoint coordinates for each of the license plate images. For example, capturing the endpoint coordinates by the signal processing circuit may be implemented through the bounding box algorithm in the object detection model. Specifically, the signal processing circuit may use the bounding box algorithm of the object detection model to obtain the boundaries of the license plate image, and then obtain multiple endpoint coordinates through the intersection points of the boundaries. In step S33′, the signal processing circuit may calculate the license plate size based on the end point coordinates, and determine the movement status of the vehicle based on changes in the end point coordinates and the license plate size during the movement of the vehicle. Specifically, the movement status of the vehicle may include a moving direction and a moving speed of the vehicle. The signal processing circuit may obtain the moving direction of the vehicle based on the above-described endpoint coordinates, and may calculate the moving speed of the vehicle based on changes in the license plate size. In step S5 of the present embodiment, the signal processing circuit may determine whether to activate the power supply circuit based on the above-described movement status and a position of the vehicle. Specifically, when the signal processing circuit determines that the vehicle is in a moving state, the signal processing circuit controls the power supply circuit not to provide electric power to the charging gun; or, when the signal processing circuit determines that the position of the vehicle is not within a certain range, the signal processing circuit controls the power supply circuit not to provide electric power to the charging gun. In addition, the electric vehicle smart charging system in the present embodiment may perform a parking timing function. For example, the electric vehicle smart charging system may determine the parking time of the vehicle based on the above-described movement status.

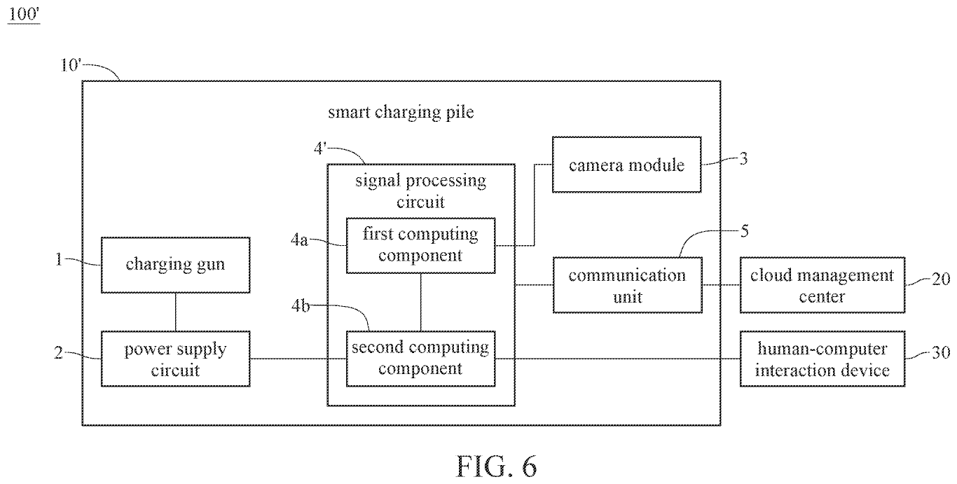

Please refer to FIG. 6, FIG. 6 is a functional block diagram of an electric vehicle smart charging system according to another embodiment of the present disclosure. As shown in FIG. 6, compared with the embodiment shown in FIG. 1, the electric vehicle smart charging system 100′ not only includes a smart charging pile 10′ and a cloud management center 20, but also includes a human-computer interaction device 30, and the smart charging pile 10′ not only includes a charging gun 1, a power supply circuit 2, a camera module 3, and a signal processing circuit 4′, but also includes a communication unit 5 in signal connection with the cloud management center 20. In the present embodiment, the signal processing circuit 4′ includes a first computing component 4a and a second computing component 4b, wherein the first computing component 4a is electrically connected to the camera module 3 and is configured to perform edge computation or smart detection including determination of the ambient light, etc., the second computing component 4b is electrically connected to the first computing component 4a and the power supply circuit 2, and is configured to control the power supply circuit 2 based on the result of the edge computation and the smart detection. Smart detection may be achieved through camera module 3 or other photosensitive elements. The communication unit 5 is electrically connected to the signal processing circuit 4 and the cloud management center 20, and is configured to transmit the results of edge computation to the cloud management center 20. The human-computer interaction device 30 is in signal connection with the second computing component 4b, and the second computing component 4b is further configured to control the power supply circuit 2 according to a user instruction input by a user through the human-computer interaction device 30. The first computing component 4a may be in signal connection with the second computing component 4b through a Universal Asynchronous Receiver/Transmitter (UART), an inter-integrated circuit (I2C), a System Management Bus (SMBUS) or a bluetooth circuit (Bluetooth).

The first computing component 4a in the present embodiment may be implemented through a neural network processing unit (NPU), and is configured to perform image recognition on the image captured by the camera module 3 according to the recognition model, so as to recognize characteristic objects such as license plates or cars etc. The second computing component 4b may be implemented through a microcontroller, a graphics processor, a programmable logic array, etc., and is configured to control the power supply circuit 2 based on the result of image recognition (edge computation). The communication unit 5 may be implemented through a device with wireless communication capabilities, and is configured as being a signal connection between the cloud management center 20 and the signal processing circuit 4′. For example, the signal processing circuit obtains images and parking-related information through artificial intelligence applications. The signal processing circuit may use the RESTful API Internet exchange information interface and the Open Charge Point Protocol 1.6 (OCPP 1.6) application layer communication protocol to transmit information, and use the HTTP Secure (HTTPS) to encrypt connection channel, encrypt and transmit data to the cloud management center using Secure Sockets Layer (SSL) or Transport Layer Security (TLS) to achieve information encryption and charging pile communication standardization, making the present embodiment safe and versatile in information transmission. The human-computer interaction device 30 may be implemented through a touch screen or other visual interface, and is configured to allow the user to input user instructions. In one implementation, the user may select the charging scheme of the electric vehicle by inputting user instructions to control the power provided to the charging gun by the power supply circuit.

The electric vehicle smart charging system 100′ of the present embodiment may be combined with the above-described embodiment. For example, the first computing component 4a may execute step S3 shown in FIG. 2, steps S31 to S34 shown in FIG. 3, and steps S31′ to S33′ shown in FIG. 5. In step S34 of FIG. 3, the first computing component 4a may transmit the license plate image corresponding to the incorrect license plate number to the cloud management center 20 through the communication unit 5. The second computing component 4b may be used to perform step S5 shown in FIG. 2. The cloud management center 20 may be used to execute step S7 shown in FIG. 2 and steps S71 and S72 shown in FIG. 4. In step S72 shown in FIG. 4, the cloud management center 20 may transmit the updated recognition model back to the signal processing circuit through the communication unit 5. In addition, the power supply circuit 2 in the present embodiment may include a power expansion unit, wherein the output number of the power expansion unit may be 1˜N (N is a positive integer greater than 1). The power expansion unit may use, but is not limited to, a proprietary or standard connector such as Power over Ethernet (POE) to provide electric power to an external device for other purposes, such as charging non-electric vehicles. For example, the system in the present embodiment may be combined with the power network planning of a smart city, so that the power expansion unit of the power supply circuit 2 may provide the power sources required in the peripheral equipment, or use the provided standard connector to allow various intelligent Internet of Things (AIoT) sensors using the same connector to obtain the required electric power and network connections. For example, fully autonomous driving in smart city traffic may require technique including, but not limited to, road boundary markings, being turned on only under low traffic condition, or lowering power of the smart street light to reduce power consumption under low traffic flow condition, to achieve rapid and flexible expansion of applications and reduce the cost of introducing other infrastructure in the future.

In view of the above description, an electric vehicle smart charging system uses modules with machine vision and artificial intelligence recognition capabilities to perform smart charging and smart parking management to achieve designs of smart application and management. The recognition module on the application end of the smart charging system of the present disclosure is designed as an edge computation architecture, and model training is designed as a backend cloud computing architecture. The edge-computed images and inference information may be sent back to the cloud to supplement the deep learning image recognition training data set to correct wrong determination and perform learning again.

Therefore, the accuracy of image recognition and labeling efficiency are effectively improved, and further deep learning is achieved. The trained recognition model is then updated via the Internet to improve the accuracy of artificial intelligence edge computation. In addition, the smart charging system in the present disclosure may be integrated into the power configuration structure required by smart cities, providing the necessary infrastructure framework, which may greatly reduce the investment cost of infrastructure and the difficulty of urban planning and beautification.

What is claimed is:

1. An electric vehicle smart charging system, comprising:
at least one smart charging pile, each comprising:
a charging gun;
a power supply circuit electrically connected to the charging gun and configured to provide electric power to the charging gun;
a camera module configured to capture at least one image associated with a vehicle; and
a signal processing circuit having at least one recognition model, the signal processing circuit electrically connected to the power supply circuit and the camera module, configured to use the at least one recognition model to perform an edge computation on the at least one image and control the power supply circuit according to a result of the edge computation, and
a cloud management center in signal connection with the signal processing circuit and configured to update the at least one recognition model of the signal processing circuit according to the result from the signal processing circuit.

2. The electric vehicle smart charging system of claim 1, wherein the cloud management center has a deep learning model, and the cloud management center is configured to use the deep learning model to train the at least one recognition model of the signal processing circuit according to the result of the edge computation.

3. The electric vehicle smart charging system of claim 1, wherein the camera module is configured to obtain a plurality of images in a continuous process of vehicle movement, the signal processing circuit has a license plate recognition model and a text recognition model, and the signal processing circuit is configured to:
analyze the plurality of images in the continuous process of vehicle movement through the license plate recognition model, and capture a plurality of license plate images;
analyze the plurality of license plate images through the text recognition model to obtain a plurality of pieces of license plate number information corresponding to the plurality of license plate images;
obtain a confidence license plate number based on the plurality of pieces of license plate number information; and
determine whether to activate the power supply circuit according to the confidence license plate number.

4. The electric vehicle smart charging system of claim 3, wherein signal processing circuit is further configured to:
obtain an incorrect license plate number based on the plurality of pieces of license plate number information,
and the cloud management center is configured to:
train the at least one recognition model of the signal processing circuit according to the incorrect license plate number.

5. The electric vehicle smart charging system of claim 1, wherein the camera module is configured to obtain a plurality of images in a continuous process of vehicle movement, the signal processing circuit has a license plate recognition model, and the signal processing circuit is configured to:
analyze the plurality of images in the continuous process of vehicle movement through the license plate recognition model, and capturing a plurality of license plate images;
acquire a plurality of endpoint coordinates for each of the plurality of license plate images;
obtain a license plate size from the plurality of endpoint coordinates, and determining a movement status of the vehicle based on changes in the plurality of endpoint coordinates and the license plate size in the continuous process; and
determine whether to activate the power supply circuit according to the movement status.

6. The electric vehicle smart charging system of claim 1, wherein one of the at least one smart charging pile further comprises a communication unit electrically connected to the signal processing circuit and in communication connection the cloud management center and configured to transmit the result of the edge computation to the cloud management center.

7. The electric vehicle smart charging system of claim 1, wherein the signal processing circuit comprises:
a first computing component electrically connected to the camera module and configured to perform the edge computation or a smart detection including determination of ambient light; and
a second computing component electrically connected to the first computing component and the power supply circuit, and configured to control the power supply circuit based on the result of the edge computation and the smart detection.

8. The electric vehicle smart charging system of claim 7, wherein the first computing component is in signal connection with the second computing component through a Universal Asynchronous Receiver/Transmitter, an inter-integrated circuit (I2C), a System Management Bus or a bluetooth circuit.

9. The electric vehicle smart charging system of claim 7, further comprising a human-computer interaction device in signal connection with the second computing component, wherein the second computing component is further configured to control the power supply circuit according to a user instruction input by a user through the human-computer interaction device.

10. The electric vehicle smart charging system of claim 1, wherein the power supply circuit comprises a power expansion unit, and the power expansion unit is configured to provide electric power to an external device.
